(19) United States
(12) Patent Application Publication
(10) Pub. No.: US 2005/0231495 A1
(43) Pub. Date: Oct. 20, 2005

(54) Display device

(75) Inventor: Osamu Ishibashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/105,508

(22) Filed: Apr. 14, 2005

(30) Foreign Application Priority Data
Apr. 15, 2004 (JP) 2004-120934

(51) Int. Cl. G09G 3/36

(52) U.S. Cl. 345/204

(57) ABSTRACT

The first and second external circuit connection terminals are provided at the corner portion between the scanning line drive unit and signal line drive unit, which are mounted at a frame portion other than the display pixel area of a glass substrate. By forming the first and second external circuit connection terminals along two sides of the corner portion, a space for connecting all wires of the external circuit connection FPC cable can be secured without widening the frame portion restricted by the width in the narrow sides of the scanning line drive unit and signal line drive unit. As a result, the external circuit connection FPC cable can be connected without requiring to widen the width of the frame portion.

### BACKGROUND OF THE INVENTION

1. Field of the Invention

The present invention relates to a display device in which spacing saving of a wiring portion between a drive device and a flexible cable for connection is targeted.

2. Description of the Related Art

Recently, in a liquid crystal display panel composed so as to seal a liquid crystal layer by being placed between two glass substrates, a liquid crystal display device has been put into practice, in which drive devices are mounted outside a display pixel area at the circumferential portion of one glass substrate, and in an area not covered up by the other glass substrate opposed thereto (hereinafter, the area is called a “frame portion”).

For example, in a prior art liquid crystal display device described in FIG. 1 of Japanese Published Unexamined Patent Application No. 2002-131772, such a technology has been disclosed, in which at least one semiconductor chip is incorporated in at least one frame portion of the liquid crystal display panels, at the same time, a plurality of connection terminal electrodes for the periphery are formed, and the semiconductor chip and respective connection terminals are juxtaposed in the lengthwise direction of the frame portion. In the prior art liquid crystal display device, two transparent substrates are adhered to each other so as to seal liquid crystal therebetween, wherein a driver analog circuit for driving a number of pixel transparent electrodes in the two transparent substrates for display and a logic circuit consisting of a control circuit for controlling the driver analog circuit and/or a memory circuit are formed in the semiconductor chip incorporated in the frame portion. In addition, an FFC (Flexible Flat Cable) is connected to the connection terminal electrodes. Further, a number of pattern wires for connecting the semiconductor chip and respective pixel transparent electrodes in the two transparent substrates to each other are formed in the frame portion. The semiconductor chip and respective connection terminal electrodes are juxtaposed and disposed in the lengthwise direction of the frame portion. Therefore, the width dimension thereof in the frame portion can be made smaller than in a case where the semiconductor chip and respective connection terminal electrodes are juxtaposed in the width direction of the frame portion.

Also, in the prior art liquid crystal display device described in FIG. 1 of Japanese Published Unexamined Patent Application No. H11-297760, such a technology is disclosed, in which a drive IC whose plan view is roughly trapezoidal is utilized. The drive IC is disposed so that its upper side is faced to the side where a stripe-formed electrode connected to a scanning line or signal line is formed, and its bottom side is faced to the side where an input terminal to an FPC (Flexible Printed Circuit) or a connector is formed. The bump electrodes of the drive IC are arrayed along the chip side, and diagonally arrayed bump electrodes are diagonally arrayed on the place position corresponding to the diagonal sides of the trapezoid. Electrode terminals at the substrate side where these diagonally arrayed bump electrodes are mounted are also diagonally arrayed, wherein it is possible to draw wiring patterns in the shortest-cut channel without diverting the wiring patterns on the substrate in long distances. Therefore, in Japanese Published Unexamined Patent Application No. H11-297760, it is described that useless space in the frame portion can be eliminated, and electric resistance of the wiring patterns can be lowered.

However, in the liquid crystal display devices disclosed in the above-described Japanese Published Unexamined Patent Application No. 2002-131772 and Japanese Published Unexamined Patent Application No. H11-297760, there are problems described below. Where a scanning line drive unit and a signal line drive unit are, respectively, mounted in the two frame portions, it is necessary to connect an FFC to the scanning line drive unit and signal line drive unit, respectively. For this reason, parts costs and mounting costs are required for two FFCs, respectively, wherein the costs of the liquid crystal display device are increased.

To the contrary, for example, in the liquid crystal display device described in FIG. 2 of Japanese Patent Publication No. 3033124, such a technology is disclosed, in which an external circuit connection terminal is provided at the corner portion placed between the frame portion in which a scanning line drive unit is mounted and the frame portion in which a signal line drive unit is mounted, and wiring is provided so that the wiring is connected from the terminal portion to both an input terminal of the scanning line drive unit and an input terminal of the signal line drive unit.

FIG. 1 is a perspective view showing such a prior art liquid crystal display device. As shown in FIG. 1, in the prior art liquid crystal display device, a glass substrate 1 on which pixel electrodes (not illustrated) are disposed in the form of a matrix, and a glass substrate 2 on which counter electrodes (not illustrated) are formed are adhered to each other so that liquid crystal is sealed therebetween. A scanning line drive unit 3 for outputting scanning pulses to the pixel electrodes and a signal line drive unit 4 for outputting picture signals to the pixel electrodes are mounted in the frame portion of the glass substrate 1. Further, in the frame portion of the glass substrate, an external circuit connection FPC cable 5 for transmitting control signals and power voltage from the periphery to the scanning line drive unit 3 and signal line drive unit 4 is connected to the corner portion between the scanning line drive unit 3 and the signal line drive unit 4.

FIG. 2 is an enlarged plan view showing a portion surrounded by broken lines in FIG. 1. As shown in FIG. 2, a plurality of scanning lines 16 and a plurality of signal lines 17 are formed on the surface of the glass substrate 1 so as to be orthogonal to each other, and display pixel electrodes (not illustrated) are connected to the intersections thereof via thin-film transistors for applying a voltage to the display pixel electrodes, thereby forming a display pixel area. A glass substrate 2 is adhered in the display pixel areas so as to seal liquid crystal. In addition, a plurality of scanning line electrode terminals (not illustrated) are arrayed on one side of the frame portion of the glass substrate 1, and a plurality of signal line electrode terminals (not illustrated) are arrayed on the other side adjacent thereto. Scanning lines 16 are connected to the respective scanning line electrode terminals, and signal lines 17 are connected to the respective signal line electrode terminals. The scanning line electrode terminals are connected to a plurality of scanning line drive output terminals 18 arrayed in the lengthwise direction of the scanning line drive unit 3. Respective signal line electrode terminals are connected to signal line drive output terminals 20 arrayed in the lengthwise direction of the signal line drive unit 4.

The scanning line drive unit 3 is provided with a scanning line drive circuit (not illustrated) composed of a polycrystal silicon thin film transistor in order to supply a voltage to the scanning lines 16. In addition, a plurality of input terminals 19 for inputting signals to control the above-described scanning line drive circuit from the periphery in the narrow side direction in the scanning line drive unit 3. The respective input terminals 19 are, respectively, connected to a plurality of electrodes secured on the surface of the glass substrate 1, which correspond to the respective input terminals 19, by soldering, etc. These electrodes are connected to a plurality of external circuit connection terminals 22 to be connected to the external circuit connection FPC cable 5 via metallic wires 24.

The signal line drive unit 4 is provided with signal line drive circuits (not illustrated) composed of polycrystal silicon thin film transistors in order to supply a voltage to the signal lines 17. Also, in the signal line drive unit 4, a plurality of input terminals 21 for inputting signals to control the above-described signal line drive circuits from the periphery are arrayed in the narrow side direction. The respective input terminals 21 are connected to a plurality of electrodes (not illustrated) secured on the surface of the glass substrate 1, which correspond to the respective input terminals 21, by soldering, etc. These electrodes are connected to a plurality of external circuit connection terminals 23 to be connected to the external circuit connection FPC cable 5 via metallic wires 25.

The above-described external circuit connection terminals 22 and 23 are arrayed in a line at one side of the frame portion of the glass substrate 1, and are connected to the electrode terminals (not illustrated) secured at the external circuit connection FPC cable 5.

However, problems described below remain in the above-described prior art technologies. In the liquid crystal display device described in Japanese Patent Publication No. 3033124, it is impossible to decrease the width dimension of the frame portion because of being restricted by the width of the external circuit connection FPC cable. In line with development of technology in recent years, the width of the drive device is made narrow to 4 mm or less. The scanning line drive unit and signal line drive unit require four systems of power wires, a ground wire, eighteen picture signal wires, ten gradation voltage wires, sixteen control signal wires, two clock signal wires, and a power wire for supplying power to the counter electrode of the display pixel electrode of a liquid crystal display panel. Herein, for example, it is assumed that a one-sided FPC cable, 10 cm long, in which copper wiring having a wiring width of 40 μm, wiring pitch of 80 μm and wiring thickness of 20 μm is provided is used for external circuit connections. Where a current of 50 mA is supplied to four systems of power sources and a power source of a counter electrode, it is necessary to prepare six or more wires for each of the power sources in order to suppress the voltage drop of the FPC cable to 0.02V or less since the resistivity of copper wiring is 1.7×10⁻⁸Ω•m. In addition, where a current of 100 mA is supplied, it is necessary to prepare 12 or more ground wires in order to suppress the voltage drop in the FPC cable to 0.02V or less as in the above. Based thereon, totally, eighty-eight or more wires are required, wherein the width of the FPC cable becomes 7.0 mm or more. Therefore, the width of the FPC cable exceeds 4 mm even if the width of the drive device becomes 4 mm or less, and the width dimension of the frame portion is obliged to be widened in order to connect the external circuit connection FPC cable.

### SUMMARY OF THE INVENTION

It is an object of the invention to provide a display device which is capable of saving space of the frame portion of a display panel in which drive devices and external circuit connection FPC cables are incorporated.

A display device according to the first aspect of the invention comprises: a display panel provided with a plurality of display pixels disposed in the form of a matrix, a plurality of signal lines for transmitting picture signals to the display pixels, a plurality of scanning lines for transmitting scanning pulses to the display pixels, and a frame portion in the periphery of a display pixel area having the display pixels provided therein; a signal line drive unit for supplying picture signals to the signal lines mounted in one side of the frame portion; a scanning line drive unit, mounted in a side adjacent to the one side of the frame portion, for supplying scanning pulses to the scanning lines; an external circuit connection terminal portion divided into a plurality of parts and disposed at one corner portion of the frame portion; and a single external circuit connection flexible cable, connected to the plurality of external circuit connection terminal portions, for supplying signals, which control the signal line drive unit and scanning line drive unit, and a power source voltage.

A display device according to the second aspect of the invention comprises: a display panel provided with a plurality of display pixels disposed in the form of a matrix, a plurality of signal lines for transmitting picture signals to the display pixels, a plurality of scanning lines for transmitting scanning pulses to the display pixels, and a frame portion in the periphery of a display pixel area having the display pixels provided therein; a signal line drive unit for supplying picture signals to the signal lines mounted in one side of the frame portion; a scanning line drive unit, mounted in a side adjacent to the one side of the frame portion, for outputting scanning pulses to the scanning lines; an external circuit connection terminal portion provided at one corner portion of the frame portion, in which a plurality of terminals are arrayed in one direction; and a single external circuit connection flexible cable, connected to the external circuit connection terminal portion, for supplying signals, which control the signal line drive unit and scanning line drive unit, and a power source voltage. And, either the signal line drive unit or the scanning line drive unit is inclined so that the end edge at the external circuit connection terminal portion side is isolated from the external circuit connection terminal portion with respect to the outer edge of the display panel.

A display device according to the third aspect of the invention comprises: a display panel provided with a plurality of display pixels disposed in the form of a matrix, a plurality of signal lines for transmitting picture signals to the display pixels, a plurality of scanning lines for transmitting scanning pulses to the display pixels, and a frame portion in the periphery of a display pixel area having the display pixels provided therein; a signal line drive unit for supplying picture signals to the signal lines mounted in one side of the frame portion; a scanning line drive unit, mounted in a side adjacent to the one side of the frame portion, for outputting scanning pulses to the scanning lines; an external circuit connection terminal portion having a plurality of terminals arrayed in one direction; and a single external circuit connection flexible cable, connected to the external circuit connection terminal portion, for supplying signals, which control the signal line drive unit and scanning line drive unit, and a power source voltage. And, either the signal line drive unit or scanning line drive unit is divided into two or three or more on the intermediate section thereof, and the end edges at the divided portions are inclined so as to widen toward the outer edges with respect to the outer edge of the display panel. The external circuit connection terminal portion is disposed in an area between the end edges of the divided portions.

A display device according to the fourth aspect of the invention comprises: a display panel provided with a plurality of display pixels disposed in the form of a matrix, a plurality of signal lines for transmitting picture signals to the display pixels, a plurality of scanning lines for transmitting scanning pulses to the display pixels, and a frame portion in the periphery of a display pixel area having the display pixels provided therein; a signal line drive unit for supplying picture signals to the signal lines mounted in one side of the frame portion; a scanning line drive unit, mounted in a side adjacent to the one side of the frame portion, for outputting scanning pulses to the scanning lines; an external circuit connection terminal portion provided at one corner portion of the frame portion; and a single external circuit connection flexible cable, connected to the external circuit connection terminal portion, for supplying signals, which control the signal line drive unit and scanning line drive unit, and a power source voltage. And, the signal line drive unit and the scanning line drive unit are inclined so that the end edge at the external circuit connection terminal portion side is isolated from the external circuit connection terminal portion with respect to the outer edge of the display panel.

According to the present invention, even if the width of the external circuit connection FPC cable is wider than the width dimension of the frame portion having a signal line drive unit incorporated therein, and/or the width dimension of the frame portion having the scanning line drive unit incorporated therein, it is possible to mount an external circuit connection FPC cable at a corner portion placed between the frame portions having two drive devices mounted therein without widening the frame portion.

### BRIEF DESCRIPTION OF THE DRAWINGS

FIG. 1 is a perspective view showing a prior art liquid crystal display device;

FIG. 2 is a plan view showing the prior art liquid crystal display device;

FIG. 3 is a perspective view showing a liquid crystal display device according to a first embodiment of the invention;

FIG. 4 is a plan view showing a liquid crystal display device according to the first embodiment of the invention;

FIG. 5 is a sectional view showing a liquid crystal display device according to the first embodiment of the invention;

FIG. 6 is a sectional view showing a liquid crystal display device according to the first embodiment of the invention;

FIG. 7 is a sectional view showing a liquid crystal display device according to the first embodiment of the invention;

FIG. 8 is a plan view showing a liquid crystal display device according to a second embodiment of the invention;

FIG. 9 is a perspective view showing a liquid crystal display device according to a third embodiment of the invention;

FIG. 10 is a plan view showing a liquid crystal display device according to the third embodiment of the invention;

FIG. 11 is a plan view showing a first modified version of a liquid crystal display device according to the third embodiment of the invention;

FIG. 12 is a perspective view showing a second modified version of a liquid crystal display device according to the third embodiment of the invention; and

FIG. 13 is a perspective view showing a third modified version of a liquid crystal display device according to the third embodiment of the invention.

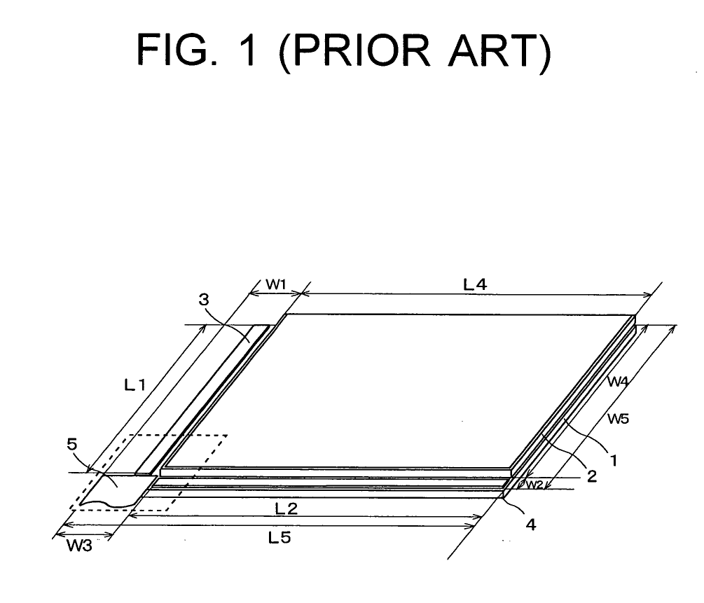

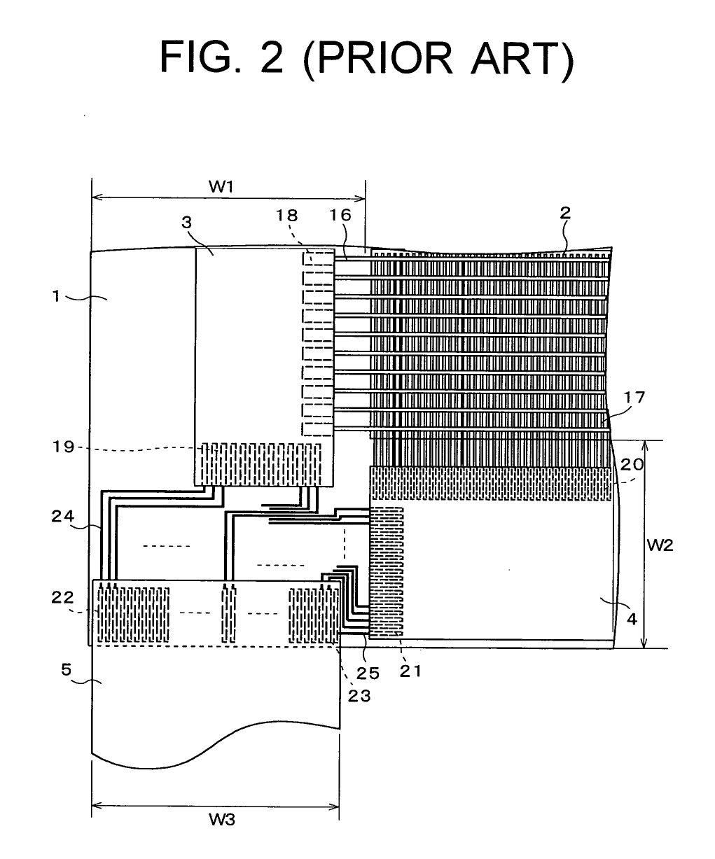

### DETAILED DESCRIPTION OF THE PREFERRED EMBODIMENTS

Hereinafter, a detailed description is given of embodiments of the invention with reference to the accompanying drawings.

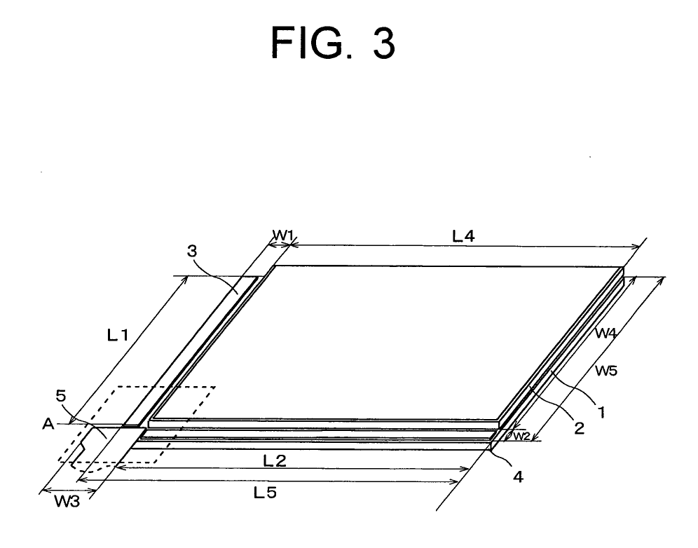

First, a first embodiment of the invention will be described below. FIG. 3 is a perspective view showing a liquid crystal display device according to the embodiment. As shown in FIG. 3, in the liquid crystal display device according to the present embodiment, a glass substrate 1 on which pixel electrodes (not illustrated) are disposed and a glass substrate 2 on which counter electrodes (not illustrated) are formed are adhered to each other so as to seal liquid crystal therebetween. Herein, the length of the glass substrate 1 is L5, and the width thereof is W5. The length of the glass substrate 2 is L4, and the width thereof is W4. A scanning line drive unit 3 for outputting scanning pulses to the pixel electrodes and a signal line drive unit 4 for outputting picture signals to the pixel electrodes are mounted at the frame portion of the glass substrate 1. The length in the lengthwise direction of the scanning line drive unit 3 is L1, and the width thereof is W1 (W1≦4 mm). The length in the lengthwise direction of the signal line drive unit 4 is L2, and the width thereof is W2 (W2≦4 mm). In addition, an external circuit connection FPC cable 5 for transmitting control signals and a power source voltage from the periphery to the scanning line drive unit 3 and signal line drive unit 4 is connected to the corner portion between the scanning line drive unit 3 and the signal line drive unit 4 in the frame portion of the glass substrate 1. The width of the external circuit connection FPC cable 5 is W3.

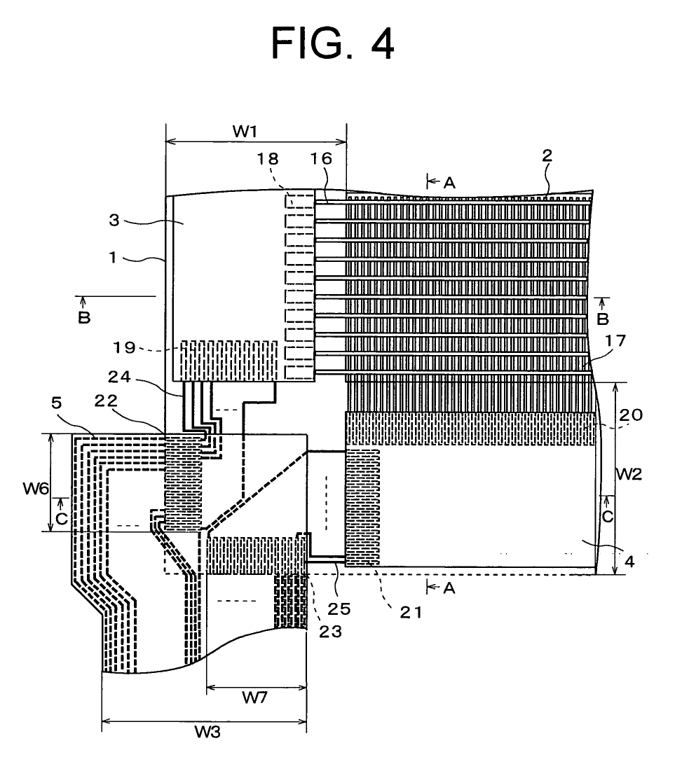

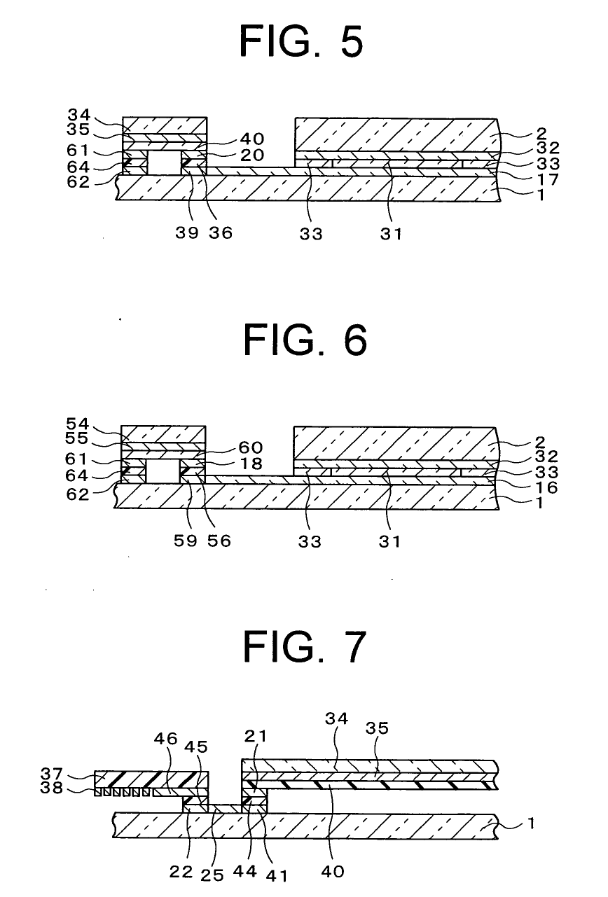

FIG. 4 is an enlarged plan view showing a portion surrounded by a broken line shown in FIG. 3. As shown in FIG. 4, a plurality of scanning lines 16 and a plurality of signal lines 17 are formed on the surface of the glass substrate 1 so as to be orthogonal to each other. Display pixel electrodes (not illustrated) are connected to the intersections thereof via thin film transistors for applying a voltage to the display pixel electrodes, thereby forming a display pixel area. In the display pixel area, the glass substrate 2 is adhered so as to seal liquid crystal 31 (Refer to FIG. 5). Further, a plurality of scanning line electrode terminals 59 (Refer to FIG. 6) are arrayed in one side of the frame portion of the glass substrate 1 while a plurality of signal line electrode terminals 39 (Refer to FIG. 5) are arrayed in the other side of the frame portion adjacent thereto. The respective scanning line electrode terminals 59 are connected to the scanning lines 16 while the respective signal line electrode terminals 39 are connected to the signal lines 17. The scanning line electrode terminals 59 are connected to a plurality of scanning line drive output terminals 18 arrayed in the lengthwise direction of the scanning line drive unit 3. The respective signal line electrode terminals 39 are connected to signal line drive output terminals 20 arrayed in the lengthwise direction of the signal line drive unit 4.

In the scanning line drive unit 3, a scanning line drive circuit 55 (Refer to FIG. 6) composed of a polycrystal silicon thin film transistor is provided in order to supply a voltage to the scanning lines 16. And, in the scanning line drive unit 3, a plurality of input terminals 19 for inputting signals to control the scanning line drive circuit 55 from the periphery are arrayed in the narrow side direction thereof. Respective input terminals 19 are, respectively, connected to a plurality of electrodes (not illustrated) secured on the surface of the glass substrate 1, which correspond to the respective input terminals 19. These electrodes are connected to a plurality of external circuit connection terminals 22 in order to be connected to the external circuit connection FPC cable 5 via metallic wires 24.

In the signal line drive unit 4, a signal line drive circuit 35 (Refer to FIG. 5) composed of a polycrystal thin film transistor is provided in order to supply a voltage to the signal lines 17. In addition, in the signal line drive unit 4, a plurality of input terminals 21 for inputting signals to control the signal line drive circuit 35 from the periphery are arrayed in the narrow side direction thereof. Respective input terminals 21 are, respectively, connected to a plurality of electrodes 41 (Refer to FIG. 7) secured on the surface of the glass substrate 1, which correspond to the respective input terminals 21. These electrodes 41 are a plurality of external circuit connection terminals 23 to be connected to the external circuit connection FPC cable 5 via metallic wires 25.

The external circuit connection terminals 22 and 23 are provided at the corner portion between the scanning line drive unit 3 and signal line drive unit 4 of the frame portion of the glass substrate 1. A plurality of external circuit connection terminals 22, which connect electrode terminals 46 secured at the external circuit connection FPC cable 5, are arrayed in the range of width W6 along one side of the corner portion, and external circuit connection terminals 23, which connect electrode terminals 46 secured at the external circuit connection FPC cable 5, are arrayed in the range of width W7 along the other side adjacent thereto. The electrode terminals 46 are connected to copper wires 38 (Refer to FIG. 7) and are connected to a peripheral circuit.

The external circuit connection terminals 22 and 23 provided at the corner portion placed between the frame portion at the scanning line electrode arraying side of the glass substrate 1 and the frame portion at the signal line electrode arraying side thereof are formed along two sides of the corner portion. The configurations of the external circuit connection terminals 22 and 23 are 0.5 mm long or less, and the width and pitch thereof are, respectively, 40 μm and 80 μm as in the copper wire 38 and electrode 46 which are provided at the external circuit connection FPC cable 5. The width W6 of an array of the external circuit connection terminals 22 and width W7 of an array of the external circuit connection terminals 23 are, respectively, 3.6 mm or so.

FIG. 5 is a sectional view taken along the line A-A′ in FIG. 4, FIG. 6 is a sectional view taken along the line B-B′ in FIG. 4, and FIG. 7 is a sectional view taken along the line C-C′ in FIG. 4. Also, illustration of the scanning lines 16 is omitted in FIG. 5. And illustration of the signal lines 17 is omitted in FIG. 6. As shown in FIG. 5, in the section cut off along the line A-A′ in FIG. 4, the signal line 17, signal line electrode terminal 39 and electrode terminal 62 are formed on the glass substrate 1. The glass substrate 2 having the counter electrodes 32 on the surface thereof is disposed to be opposed to the glass substrate 1 via a sealing material 33 so as to partially cover the signal lines 17 on the surface of the glass substrate 1, and is adhered thereto so as to seal liquid crystal 31. Further, the signal line drive circuit 35 for supplying a voltage to the signal lines 17 is formed on the glass substrate 34, and a protection insulative film 40 is further formed thereon so as to cover the signal line drive circuit 35. Still further, an output terminal 20 and an electrode terminal 61 are formed on the surface of the signal line drive circuit 35 and are, respectively, connected to a signal line electrode 39 and an electrode terminal 62 via an anisotropic electro-conductive adhesion film.

Also, as shown in FIG. 6, in the section cut off along the line B-B′ in FIG. 4, the scanning line 16, signal line electrode terminal 39 and electrode terminal 62 are formed on the surface of the glass substrate 1. The glass substrate 2 having a counter electrode 32 provided on the surface thereof is opposed to the glass substrate 1 via a sealing material 33 so as to partially cover the scanning line 16 on the surface of the glass substrate 1, and the glass substrates 1 and 2 are adhered to each other so as to seal liquid crystal 31. In addition, a scanning line drive circuit 55 for supplying a voltage to the scanning line 16 is formed on a glass substrate 54, and a protection insulative film 60 is further formed thereon so as to cover a scanning line drive circuit 55. Still further, an output terminal 18 and an electrode terminal 61 are formed on the surface of the scanning line drive circuit 55, and are, respectively, connected to a scanning line electrode 59 and an electrode terminal 62 via an anisotropic electro-conductive adhesive film.

Furthermore, as shown in FIG. 7, in the section cut off along the line C-C′ in FIG. 4, an electrode 41, an external circuit connection terminal 22 and a metallic wire 25 are formed on the glass substrate 1, wherein the electrode 41 and the external circuit connection terminal 22 are connected to each other via the metallic wire 25. The signal line drive circuit 35 is formed on the glass substrate 34, and an insulative film 40 is further formed so as to cover the signal line drive circuit 35. Also, an input terminal 21 is formed on the signal line drive circuit 35 and is connected to an electrode 41 via an anisotropic electro-conductive adhesion film 44. Further, a copper wire 38 and an electrode terminal 46 for connection to an external circuit (not illustrated) to control the signal line drive circuit 35 are formed on a film substrate 37. The electrode terminal 46 is connected to an external circuit connection terminal 22 on the glass substrate 1 via an anisotropic electro-conductive adhesion film 45.

Next, a description is given of operations of the liquid crystal display device according to the present embodiment constructed as described above. As shown in FIG. 3 through FIG. 7, control signals are inputted from an external circuit (not illustrated) into the scanning line drive unit 3 and signal line drive unit 4 via the external circuit connection FPC cable 5 and glass substrate 1. In accordance with the control signals, the scanning line drive unit 3 outputs scanning pulses to the pixel electrodes via the scanning lines 16, and the signal line drive unit 4 outputs picture signals to the pixel electrodes via the signal lines 17. The voltage between the pixel electrodes and counter electrodes 32 changes by these signals, and the orientation state of liquid crystal 31 placed between the pixel electrodes and counter electrodes 32 is varied in accordance therewith.

The copper wire 38 and electrode terminal 46, which are provided at the external circuit connection FPC cable 5, have, for example, a width of 40 mm, pitches of 80 mm, and a thickness of 20 mm, and the length of the FPC cable 5 is 10 cm. There are eighty-eight wires, wherein the wires are connected to the external circuit connection terminals 22 and 23 by forty-four wires each. The wires are twenty-four power wires of four systems to be provided for the scanning line drive unit 3 and signal line drive unit 4, twelve ground wires, eighteen picture signal wires, ten gradation voltage wires, sixteen control signal wires, two clock signal wires, and six power wires to be provided for the counter electrodes of the display pixel electrodes of the liquid crystal display panel. The external circuit connection terminals 22 and 23 provided at the corner portion placed between the frame portion at the scanning line electrode arraying side of the glass substrate 1 and the frame portion at the signal line electrode arraying side thereof are formed along two sides of the corner portion. It is assumed that the length of the external circuit connection terminals 22 and 23 is 0.5 mm or less, and the width and pitch thereof are, respectively, 40 μm and 80 μm as in the copper wire 38 and electrode 46 which are provided in the external circuit connection FPC cable 5. The width W6 of an array of the external circuit connection terminals 22 and the width W7 of an array of the external circuit connection terminals 23 are, respectively, 3.6 mm or so. Based thereon, it is possible to secure a space for connecting all the wires of the external circuit connection FPC cable 5 without widening the frame portion restricted by the width (4 mm or less) in the narrow side of the scanning line drive unit 3 and signal line drive unit 4.

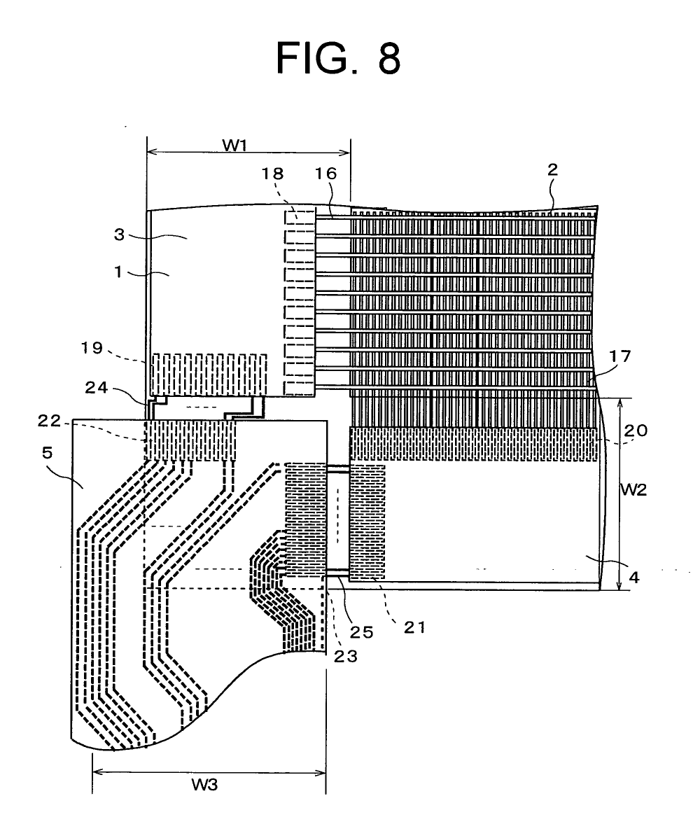

Next, a description is given of a second embodiment of the invention. FIG. 8 is a plan view showing a liquid crystal display device according to the present embodiment. In the first embodiment, as shown in FIG. 4, a plurality of external circuit connection terminals 22 are arrayed along one side of the corner portion of the glass substrate 1 while the external circuit connection terminals 23 are arrayed along the other side adjacent to the above-described side. To the contrary, in the second embodiment, as shown in FIG. 8, the external circuit connection terminals 22 and the input terminals 19 of the scanning line drive unit 3 are arrayed in the same sequence so that the terminals corresponding to each other are matched to each other. The external circuit connection terminals 23 and the input terminals 21 of the signal line drive unit 4 are arrayed in the same sequence so that the terminals corresponding to each other are matched to each other. Based thereon, the external circuit connection terminals 22 and the input terminals 19 of the scanning line drive unit 3, and the external circuit connection terminals 23 and the input terminals of the signal line drive unit 4 can be, respectively, connected by metallic wires 24 and 25 at the shortest distances, wherein design and formation of wiring patterns can be facilitated. The electrode 46 in the external circuit connection FPC cable 5 is formed at the position corresponding to the above-described external circuit connection terminals 22 and 23. The construction, operation and effects of the embodiment other than the above are the same as those of the first embodiment. In addition, in the present embodiment, either one of the external circuit connection terminals 22 and 23 may be arrayed along one side of the glass substrates, and may be provided so as to become parallel to each other.

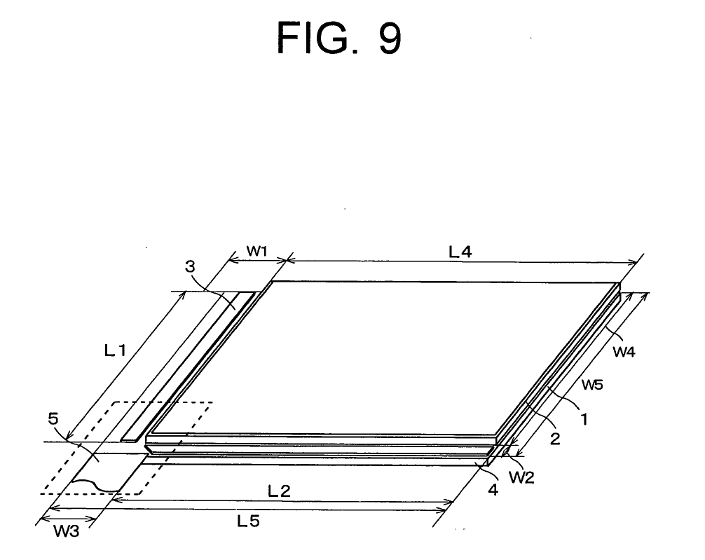

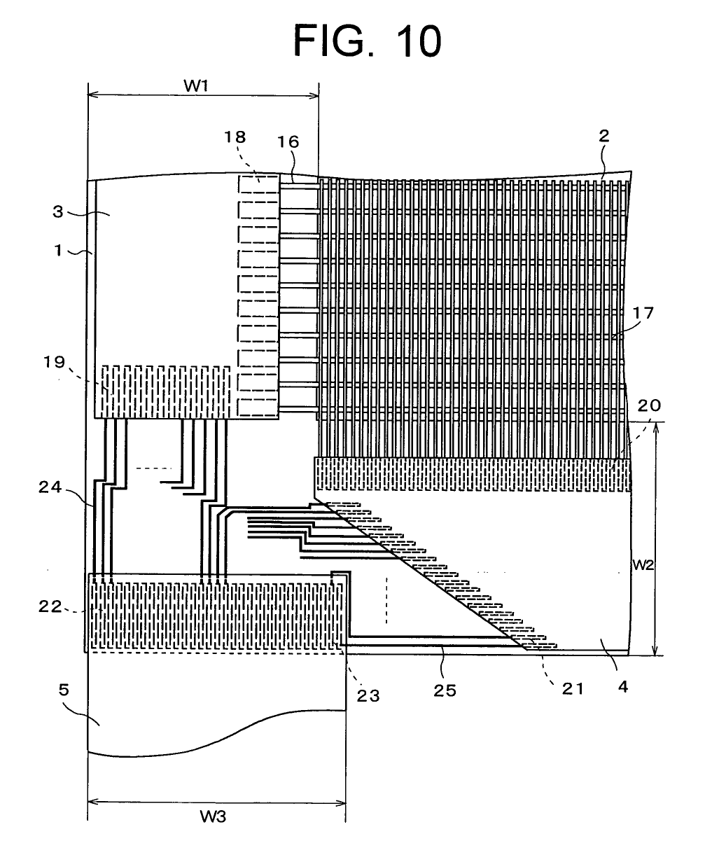

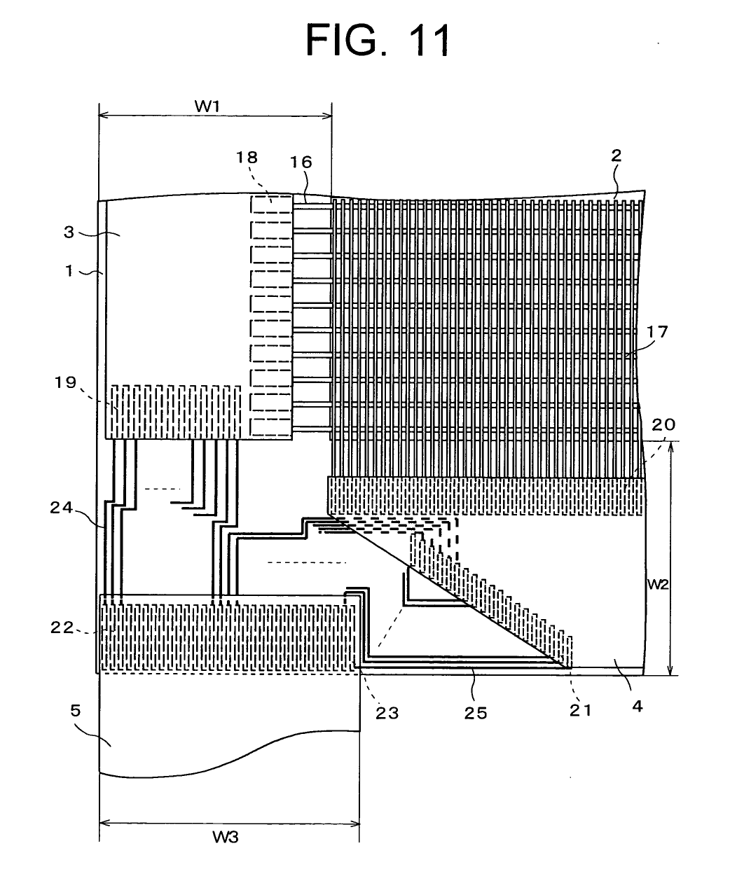

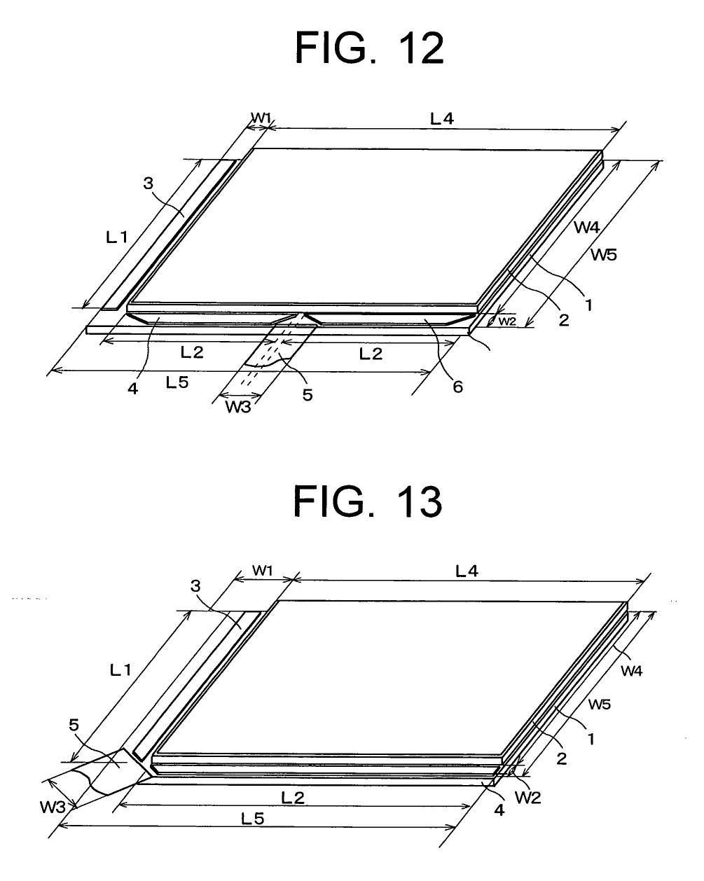

Furthermore, a description is given of a third embodiment of the invention. FIG. 9 is a perspective view showing a liquid crystal display device according to the third embodiment. Also, FIG. 10 is an enlarged plan view showing a portion surrounded by a broken line in FIG. 9, and FIG. 11 is a view showing a modified version. In addition, FIG. 12 and FIG. 13 are perspective views showing modified versions of the present embodiment described in FIG. 9.

In the above-described first embodiment, as shown in FIG. 3, a device whose plan view is rectangular is used as the signal line drive unit 4. To the contrary, in the third embodiment, as shown in FIG. 9 and FIG. 10, the narrow side along which the input terminals 21 of the signal line drive unit 4 are arrayed is inclined to the direction orthogonal to the side of the glass substrate 1. The external circuit connection terminals 22 and 23 are arrayed along one side of the corner portion of the glass substrate 1. The electrode 46 provided in the external circuit connection FPC cable 5 is formed at the position corresponding to the above-described external circuit connection terminals 22 and 23. The construction, operation and effects of the present embodiment other than the above description are the same as those in the first embodiment.

Also, in the first modified version of the present embodiment, as shown in FIG. 11, the lengthwise direction and terminal pitch of the input terminals 21 of the signal line drive unit 4 are made coincident with the lengthwise direction and terminal pitch of the output terminals. Therefore, it is sufficient that high positioning accuracy is secured only in the lengthwise direction, not requiring any high accuracy in positioning in the narrow side direction of the signal line drive unit 4.

Further, in the second modified version of the present embodiment, as shown in FIG. 12, the signal line drive unit 4 is divided into two sections, and input terminals are arrayed at the narrow sides, opposed to each other, of the two divided signal line drive units 4 and 6. Further, these sides are inclined in the direction orthogonal to the side of the glass substrate 1, wherein the external circuit connection terminals 22 and 23 are arrayed between the two signal line drive units 4 and 6. The external circuit connection terminal 22 is connected to an electrode secured on the surface of the glass substrate 1 corresponding to the input terminal 19 of the scanning line drive unit 3 via a metallic wire 24 formed on the surface of the glass substrate 1 below the signal line drive unit 4 or via a metallic wire formed on the surface of the glass substrate 1 and a metallic wire formed on the signal line drive unit 4 so as to be connected thereto.

Still further, in the third modified version of the embodiment, as shown in FIG. 13, the side along which the input terminals 21 of the signal line drive unit 4 are arrayed and the side along which the input terminals 19 of the scanning line drive unit 3 are arrayed are inclined with respect to the direction orthogonal to the side of the glass substrate 1, whereby it is possible to provide a space in which the external circuit connection terminals 22 and 23 are formed.

1. A display device comprising:
a display panel, said display panel comprising:
a plurality of display pixels disposed in the form of a matrix;
a plurality of signal lines for transmitting picture signals to said display pixels;
a plurality of scanning lines for transmitting scanning pulses to said display pixels; and
a frame portion in the periphery of a display pixel area having said display pixels provided therein;
a signal line drive unit for supplying picture signals to said signal lines mounted in one side of said frame portion;
a scanning line drive unit, mounted in a side adjacent to said one side of said frame portion, for supplying scanning pulses to said scanning lines;
a plurality of external circuit connection terminal portions divided into a plurality of parts and disposed at one corner portion of said frame portion; and
a single external circuit connection flexible cable, connected to said plurality of external circuit connection terminal portions, for supplying signals, which control said signal line drive unit and scanning line drive unit, and a power source voltage.

2. The display device according to claim 1, wherein said external circuit connection terminal portion is provided at the corner portion between said signal line drive unit and said scanning line drive unit at said frame portion.

3. The display device according to claim 2, wherein said signal line drive unit comprises:
a signal line drive circuit for generating a drive voltage for said signal lines;
an input terminal portion, connected to said external circuit connection terminal portion, for inputting picture signals, control signals and a power source voltage from the periphery; and
an output terminal portion, connected to said signal lines, for supplying picture signals to said signal lines.

4. The display device according to claim 3, wherein said scanning line drive unit comprises:
a scanning line drive circuit for generating a drive voltage for said scanning lines;
an input terminal portion, connected to said external circuit connection terminal portion, for inputting control signals and a power source voltage from the periphery; and
an output terminal portion, connected to said scanning lines, for supplying scanning pulses to said scanning lines.

5. The display device according to claim 4, wherein said external circuit connection terminal portion is divided into two sections and is provided along the outer edge of the corner portion.

6. The display device according to claim 5, wherein said input terminal portion of said signal line drive unit and said input terminal portion of said scanning line drive unit are faced to the corner portion between said signal line drive unit and said scanning line drive unit.

7. The display device according to claim 4, wherein said external circuit connection terminal portion is divided into two sections and said respective sections thereof are disposed at said side facing the corner portion of said signal line drive unit and at said side facing the corner portion of said scanning line drive unit.

8. The display device according to claim 7, wherein said input terminal portion of said signal line drive unit and said input terminal portion of said scanning line drive unit are faced to the corner portion between said signal line drive unit and said scanning line drive unit, and said two-divided external circuit connection terminal portions are, respectively, disposed at and faced to said input terminal portion of said signal line drive unit and said input terminal portion of said scanning drive device.

9. The display device according to claim 8, wherein said two-divided external circuit connection terminal portions, input terminal portion of said signal line drive unit, and input terminal portion of said scanning line drive unit are, respectively, provided with a plurality of terminals; respective terminals of said external circuit connection terminal portions and respective terminals of said input terminal portion of said signal line drive unit are arrayed in said same sequence so that said terminals corresponding to each other are matched to each other; and respective terminals of said external circuit connection terminal portions and respective terminals of said input terminal portion of said scanning line drive unit are arrayed in said same sequence so that said terminals corresponding to each other are matched to each other.

10. The display device according to claim 1, wherein said connection portion of said flexible cable with said external circuit connection terminal portion is wider than said width of said frame portion.

11. The display device according to claim 1, wherein each of said signal line drive unit and said scanning line drive unit comprises:
a transparent substrate; and
a singular or a plurality of thin film transistors provided on the surface of said transparent substrate.

12. The display device according to claim 1, wherein said signal lines and said output terminal portion of said signal line drive unit are electrically connected to each other by a wiring pattern provided at said frame portion; said scanning lines and said output terminal portion of said scanning line drive unit are electrically connected to each other by a wiring pattern provided at said frame portion; said external circuit connection terminal portion and said input terminal portion of said signal line drive unit are electrically connected to each other by a wiring pattern provided at said frame portion; and said external circuit connection terminal portion and said input terminal portion of said scanning line drive unit are electrically connected to each other by a wiring pattern provided at said frame portion.

13. A display device comprising:
a display panel, said display panel comprising:
a plurality of display pixels disposed in the form of a matrix;
a plurality of signal lines for transmitting picture signals to said display pixels;
a plurality of scanning lines for transmitting scanning pulses to said display pixels; and
a frame portion in the periphery of a display pixel area having said display pixels provided therein;
a signal line drive unit for supplying picture signals to said signal lines mounted in one side of said frame portion;
a scanning line drive unit, mounted in a side adjacent to said one side of said frame portion, for outputting scanning pulses to said scanning lines;
an external circuit connection terminal portion provided at one corner portion of said frame portion, in which a plurality of terminals are arrayed in one direction; and
a single external circuit connection flexible cable, connected to said external circuit connection terminal portion, for supplying signals, which control said signal line drive unit and scanning line drive unit, and a power source voltage,
wherein either said signal line drive unit and said scanning line drive unit is inclined so that the end edge at said external circuit connection terminal portion side is isolated from said external circuit connection terminal portion with respect to the outer edge of said display panel.

14. The display device according to claim 13, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines; and
said scanning line drive unit comprises:
a scanning line drive circuit for generating a drive voltage for said scanning lines;
an input terminal, connected to said external circuit connection terminal portion, for inputting control signals and a power source voltage from the periphery;
an output terminal, connected to said scanning lines, for supplying scanning pulses to said scanning lines; and
wherein said input terminal of said signal line drive unit and said input terminal of said scanning line drive unit are faced to the corner portion at which said external circuit connection terminal portion is provided; and one of said input terminals is disposed so that said terminal is inclined so as to be isolated from said external circuit connection terminal portion with respect to the outer edge of said display panel.

15. The display device according to claim 14, wherein said input terminals inclined and disposed so as to be isolated from said external circuit connection terminal portion with respect to the outer edge of said display panel are disposed so that said lengthwise direction thereof is said same as said lengthwise direction of said output terminals secured in said same device.

16. The display device according to claim 13, wherein said width of said connection of said flexible cable with said external circuit connection terminal portion is wider than said width of said frame portion.

17. The display device according to claim 13, wherein each of said signal line drive unit and said scanning line drive unit comprises:
a transparent substrate; and
a singular or a plurality of thin film transistors secured on the surface of said transparent substrate.

18. A display device comprising:
a display panel, said display panel comprising:
a plurality of display pixels disposed in the form of a matrix;
a plurality of signal lines for transmitting picture signals to said display pixels;
a plurality of scanning lines for transmitting scanning pulses to said display pixels; and
a frame portion in the periphery of a display pixel area having said display pixels provided therein;
a signal line drive unit for supplying picture signals to said signal lines mounted in one side of said frame portion;
a scanning line drive unit, mounted in a side adjacent to said one side of said frame portion, for outputting scanning pulses to said scanning lines;
an external circuit connection terminal portion having a plurality of terminals arrayed in one direction; and
a single external circuit connection flexible cable, connected to said external circuit connection terminal portion, for supplying signals, which control said signal line drive unit and scanning line drive unit, and a power source voltage,
wherein either said signal line drive unit and scanning line drive unit is divided into two or more on said intermediate section thereof, and the end edges at said divided portions are inclined so as to widen toward the outer edges with respect to the outer edge of said display panel, said external circuit connection terminal portion is disposed in an area between the end edges of said divided portions.

19. The display device according to claim 18, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines; and
said scanning line drive unit comprises:
a scanning line drive circuit for generating a drive voltage for said scanning lines;
an input terminal, connected to said external circuit connection terminal portion, for inputting control signals and a power source voltage from the periphery; and
an output terminal, connected to said scanning lines, for supplying scanning pulses to said scanning lines,
wherein one of said input terminal of said signal line drive unit and said input terminal of said scanning line drive unit is inclined to the outer edge of said display panel.

20. The display device according to claim 19, wherein said input terminal inclined to the outer edge of said display panel is disposed so that said lengthwise direction thereof is said same as said lengthwise direction of said output terminal provided in said same device.

21. The display device according to claim 18, wherein each of said signal line drive unit and said scanning line drive unit comprises:
a transparent substrate; and
a singular or a plurality of thin film transistors provided on the surface of said transparent substrate.

22. A display device comprising:
a display panel, said display panel comprising:
a plurality of display pixels disposed in the form of a matrix;
a plurality of signal lines for transmitting picture signals to said display pixels;
a plurality of scanning lines for transmitting scanning pulses to said display pixels; and
a frame portion in the periphery of a display pixel area having said display pixels provided therein;
a signal line drive unit for supplying picture signals to said signal lines mounted in one side of said frame portion;
a scanning line drive unit, mounted in a side adjacent to said one side of said frame portion, for outputting scanning pulses to said scanning lines;
an external circuit connection terminal portion provided at one corner portion of said frame portion; and
a single external circuit connection flexible cable, connected to said external circuit connection terminal portion, for supplying signals, which control said signal line drive unit and scanning line drive unit, and a power source voltage,
wherein said signal line drive unit and said scanning line drive unit are inclined so that the end edge at said external circuit connection terminal portion side is isolated from said external circuit connection terminal portion with respect to the outer edge of said display panel.

23. The display device according to claim 22, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines; and
said scanning line drive unit comprises:
a scanning line drive circuit for generating a drive voltage for said scanning lines;
an input terminal, connected to said external circuit connection terminal portion, for inputting control signals and a power source voltage from the periphery;
an output terminal, connected to said scanning lines, for supplying scanning pulses to said scanning lines; and
wherein said input terminal of said signal line drive unit and said input terminal of said scanning line drive unit are faced to the corner portion at which said external circuit connection terminal portion is provided; and either one of said input terminals is disposed so that said terminal is inclined so as to be isolated from said external circuit connection terminal portion with respect to the outer edge of said display panel.

24. The display device according to claim 23, wherein said external circuit connection terminal portion is disposed so that said terminals thereof are faced to said input terminal of said signal line drive unit and said input terminal of said scanning line drive unit.

25. The display device according to claim 22, wherein each of said signal line drive unit and said scanning line drive unit comprises:
a transparent substrate; and
a singular or a plurality of thin film transistors provided on the surface of said transparent substrate.

26. The display device according to claim 1, wherein said display panel comprises:
a plurality of display pixel electrodes disposed at said display pixels;
a first transparent substrate on which said display pixel electrodes, said signal lines, said scanning lines and said frame portion are disposed; and
a second transparent substrate having counter electrodes of said display pixel electrodes, which forms said display panel by being faced to said first transparent substrate with a liquid crystal layer placed therebetween.

27. The display device according to claim 26, wherein said external circuit connection terminal portion is provided at the corner portion between said signal line drive unit and said scanning line drive unit at said frame portion.

28. The display device according to claim 27, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines.

29. The display device according to claim 28, wherein said scanning line drive unit comprises:
a scanning line drive circuit for generating a drive voltage for said scanning lines;
an input terminal, connected to said external circuit connection terminal portion, for inputting control signals and a power source voltage from the periphery; and
an output terminal, connected to said scanning lines, for supplying scanning pulses to said scanning lines.

30. The display device according to claim 29, wherein said external circuit connection terminal is divided into two sections and is provided along the outer edge of the corner portion.

31. The display device according to claim 30, wherein said input terminal portion of said signal line drive unit and said input terminal portion of said scanning line drive unit are faced to the corner portion between said signal line drive unit and said scanning line drive unit.

32. The display device according to claim 29, wherein said external circuit connection terminal portion is divided into two sections, and said two-divided sections are, respectively, disposed along said side faced to the corner portion of said signal line drive unit and along said side faced to the corner portion of said scanning line drive unit.

33. The display device according to claim 32, wherein said input terminal of said signal line drive unit and said input terminal of said scanning line drive unit are faced to the corner portion between said signal line drive unit and said scanning line drive unit, and said two-divided external circuit connection terminal portions are, respectively, disposed so as to be faced to said input terminal of said signal line drive unit and said input terminal of said scanning line drive unit.

34. The display device according to claim 33, wherein said two-divided external circuit connection terminal portions, said input terminal portion of said signal line drive unit and said input terminal portion of said scanning line drive unit are, respectively, provided with a plurality of terminals; said respective terminals of said external circuit connection terminal portion and respective terminals of said input terminal portion of said signal line drive unit are arranged in said same sequence so that said terminals corresponding to each other are matched to each other; and said respective terminals of said external circuit connection terminal portion and said respective terminals of said input terminal portion of said scanning line drive unit are arrayed in said same sequence so that said terminals corresponding to each other are matched to each other.

35. The display device according to claim 26, wherein said connection portion of said flexible cable with said external circuit connection terminal portion is wider than said width of said frame portion.

36. The display device according to claim 26, wherein each of said signal line drive unit and said scanning line drive unit comprises:
a transparent substrate; and
a singular or a plurality of thin film transistors provided on the surface of said transparent substrate.

37. The display device according to claim 13, wherein said display panel comprises:
a plurality of display pixel electrodes disposed at said display pixels;
a first transparent substrate on which said display pixel electrodes, said signal lines, said scanning lines and said frame portion are disposed; and
a second transparent substrate having counter electrodes of said display pixel electrodes, which forms said display panel by being faced to said first transparent substrate with a liquid crystal layer placed therebetween.

38. The display device according to claim 37, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines; and
said scanning line drive unit comprises:
a scanning line drive circuit for generating a drive voltage for said scanning lines;
an input terminal, connected to said external circuit connection terminal portion, for inputting control signals and a power source voltage from the periphery;
an output terminal, connected to said scanning lines, for supplying scanning pulses to said scanning lines; and
wherein said input terminal of said signal line drive unit and said input terminal of said scanning line drive unit are faced to the corner portion at which said external circuit connection terminal portion is provided; and one of said input terminals is disposed so that said terminal is inclined so as to be isolated from said external circuit connection terminal portion with respect to the outer edge of said display panel.

39. The display device according to claim 38, wherein said input terminal disposed and inclined so as to be isolated from said external circuit connection terminal portion with respect to the outer edge of said display panel is disposed so that said lengthwise thereof is said same as said lengthwise direction of said output terminal secured in said same device.

40. The display device according to claim 37, wherein said connection portion of said flexible cable with said external circuit connection terminal portion is wider than said width of said frame portion.

41. The display device according to claim 37, wherein each of said signal line drive unit and said scanning line drive unit comprises:
a transparent substrate; and
a singular or a plurality of thin film transistors provided on the surface of said transparent substrate.

42. The display device according to claim 18, wherein said display panel comprises:
a plurality of display pixel electrodes disposed at said display pixels;
a first transparent substrate on which said display pixel electrodes, said signal lines, said scanning lines and said frame portion are disposed; and
a second transparent substrate having counter electrodes of said display pixel electrodes, which forms said display panel by being faced to said first transparent substrate with a liquid crystal layer placed therebetween.

43. The display device according to claim 42, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines; and
said scanning line drive unit comprises:
a scanning line drive circuit for generating a drive voltage for said scanning lines;
an input terminal, connected to said external circuit connection terminal portion, for inputting control signals and a power source voltage from the periphery; and
an output terminal, connected to said scanning lines, for supplying scanning pulses to said scanning lines,
wherein one of said input terminal of said signal line drive unit and said input terminal of said scanning line drive unit is inclined to the outer edge of said display panel.

44. The display device according to claim 43, wherein said input terminal inclined to the outer edge of said display panel is disposed so that said lengthwise direction thereof is said same as said lengthwise direction of said output terminal secured in said same device.

45. The display device according to claim 42, wherein each of said signal line drive unit and said scanning line drive unit comprises:
a transparent substrate; and
a singular or a plurality of thin film transistors provided on the surface of said transparent substrate.

46. The display device according to claim 22, wherein said display panel comprises:
a plurality of display pixel electrodes disposed at said display pixels;
a first transparent substrate on which said display pixel electrodes, said signal lines, said scanning lines and said frame portion are disposed; and
a second transparent substrate having counter electrodes of said display pixel electrodes, which forms said display panel by being faced to said first transparent substrate with a liquid crystal layer placed therebetween.

47. The display device according to claim 46, wherein said signal line drive unit comprises:
a signal line drive circuit for generating a drive voltage for said signal lines;
an input terminal, connected to said external circuit connection terminal portion, for inputting picture signals, control signals and a power source voltage from the periphery; and
an output terminal, connected to said signal lines, for supplying picture signals to said signal lines; and
said scanning line drive unit comprises:
a scanning line drive circuit for generating a drive voltage for said scanning lines;
an input terminal, connected to said external circuit connection terminal portion, for inputting control signals and a power source voltage from the periphery; and
an output terminal, connected to said scanning lines, for supplying scanning pulses to said scanning lines,
wherein said input terminal of said signal line drive unit and said input terminal of said scanning line drive unit are faced to the corner portion at which said external circuit connection terminal portion is provided, and either of said input terminals is disposed at and inclined so as to be isolated from said external circuit connection terminal portion with respect to the outer edge of said display panel.

48. The display device according to claim 47, wherein said external circuit connection terminal portion is arrayed so that said terminals thereof are faced to said input terminal of said signal line drive unit and said input terminal of said scanning line drive unit.

49. The display device according to claim 46, wherein each of said signal line drive unit and said scanning line drive unit comprises:
a transparent substrate; and
a singular or a plurality of thin film transistors provided on the surface of said transparent substrate.

50. The display device according to claim 46, wherein said signal lines and said output terminal portion of said signal line drive unit are electrically connected to each other by a wiring pattern provided at said frame portion; said scanning lines and said output terminal portion of said scanning line drive unit are electrically connected to each other by a wiring pattern provided at said frame portion; said external circuit connection terminal portion and said input terminal portion of said signal line drive unit are electrically connected to each other by a wiring pattern provided at said frame portion; and said external circuit connection terminal portion and said input terminal portion of said scanning line drive unit are electrically connected to each other by a wiring pattern provided at said frame portion.
